(19) United States
(12) Patent Application Publication
(10) Pub. No.: US 2025/0353337 A1
(43) Pub. Date: Nov. 20, 2025

(54) POSITIONABLE HOSES

(71) Applicant: Torc Robotics, Inc., Blacksburg, VA (US)

(72) Inventors: Akshay Pai Raikar, Austin, TX (US); Joseph R. Fox-Rabinovitz, Austin, TX (US)

(21) Appl. No.: 18/669,169

(22) Filed: May 20, 2024

(51) Int. Cl. B60D 1/64

(52) U.S. Cl. CPC B60D 1/64

(57) ABSTRACT

A system for positioning of one or more trailer lines includes a positionable hose including a plurality of billows, the positionable hose defining an interior cavity extending along a length of the positionable hose, the interior cavity is sized and shaped to contain one or more of the trailer lines therein, each of the billows includes a billow inlet, a compressed fluid source for generating a compressed fluid flow, and an inlet line fluidically connected to the compressed fluid source and the billow inlet, wherein the inlet line supplies the compressed fluid flow from the compressed fluid source through the billow inlet and into the billow to inflate the billow.

### TECHNICAL FIELD

The field of the disclosure relates generally to positionable hoses and, more specifically, positionable hoses for positioning and connecting trailer lines between a truck and a trailer.

### BACKGROUND OF THE INVENTION

Air and electrical connections, commonly referred to as trailer lines, connect one or more components of a truck to one or more components of a trailer. For example, one or more trailer lines may supply compressed air from an air compressor in the truck to an air brake system of the trailer. During trailer exchanges these trailer lines are connected and/or disconnected manually by a technician or semi-automatically with supervision of a technician. For autonomous or semi-autonomous vehicle applications, there may not be a technician or driver available to manually connect and/or disconnect the trailer lines between the truck and the trailer.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed system for positioning of one or more trailer lines for connecting a truck to a trailer includes a positionable hose including a plurality of billows. The positionable hose defines an interior cavity extending along a length of the positionable hose. The interior cavity is sized and shaped to contain one or more of the trailer lines therein. Each of the billows includes a billow inlet. The system includes a compressed fluid source for generating a compressed fluid flow and an inlet line fluidically connected to the compressed fluid source and the billow inlet. The inlet line supplies the compressed fluid flow from the compressed fluid source through the billow inlet and into the billow to inflate the billow.

In another aspect, the disclosed control system for positioning of one or more trailer lines for connecting a truck to a trailer includes a positionable hose including a plurality of billows. The positionable hose defining an interior cavity extending along a length of the positionable hose, the interior cavity is sized and shaped to contain one or more of the trailer lines therein. Each of the billows includes a billow inlet. The system includes a compressed fluid source for generating a compressed fluid flow and an inlet line fluidically connected to the compressed fluid source and the billow inlet. The inlet line supplies the compressed fluid flow from the compressed fluid source through the billow inlet and into the billow to inflate the billow. The system includes a flow control device for controlling a flow parameter of the compressed fluid flow within the inlet line and a computing system communicatively coupled to the flow control device. The computing system transmits a control signal to the flow control device to adjust a flow parameter of the compressed fluid flow.

In yet another aspect, the disclosed method for positioning a positionable hose for connecting a line connector to a trailer connector, the method comprising receiving, at a computing device, visual data from a visual detection system, determining, using the computing device, a position of the positionable hose and a position of the trailer connector. The method includes transmitting, from the computing device to a flow control device, a control signal, the control signal causing the flow control device to adjust a parameter of a compressed fluid flow supplied to the positionable hose.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic of an example positionable hose system for use with an example autonomous vehicle;

FIG. 2 is a perspective cross-section view of a positionable hose for use with the positionable hose system;

FIG. 3 is a top cross-section view of the positionable hose shown in FIG. 2;

FIG. 4 is a block diagram of an example control system for use with the positionable hose system shown in FIG. 1;

FIG. 5 is a process flow diagram for use with the positionable hose system shown in FIG. 1; and

FIG. 6 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

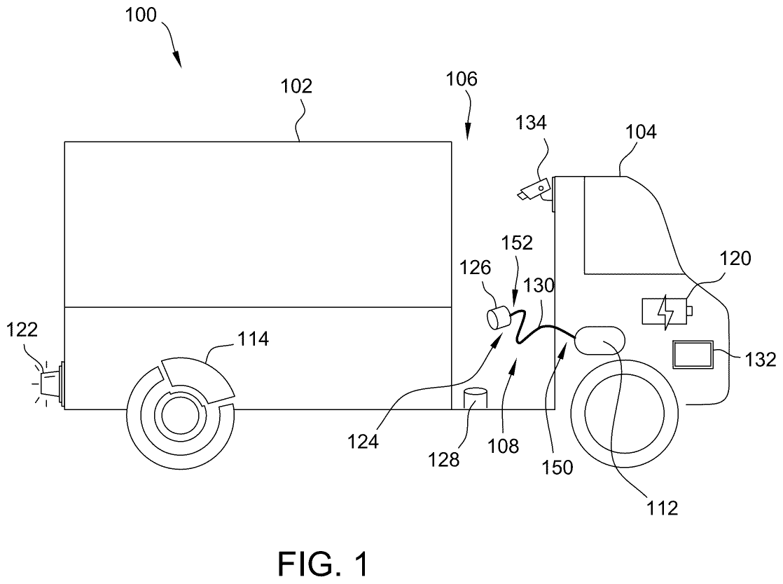

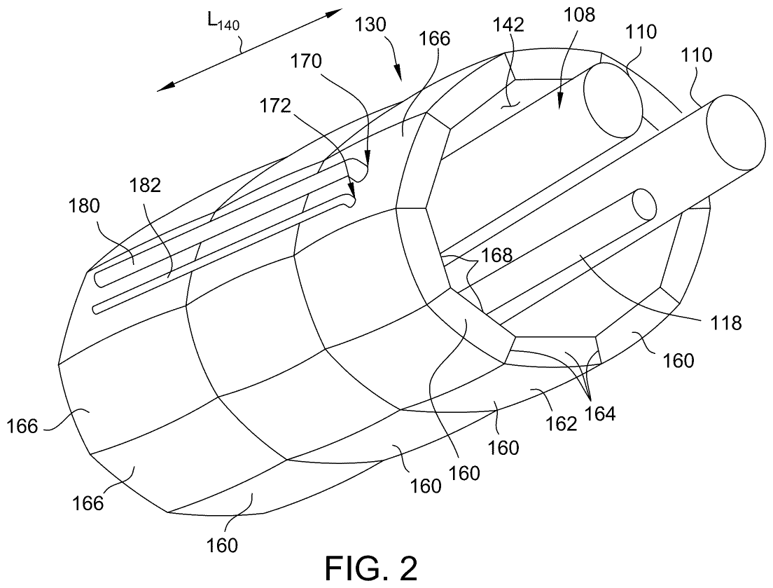

FIG. 1 is a schematic of an autonomous vehicle 100 including a trailer 102 and a truck 104, for use with a positionable hose system 106 for positioning and/or connecting one or more trailer lines 108 between the truck 104 and the trailer 102. Generally, the one or more trailer lines 108 are used to selectively connect features or components of the truck 104 to features or components of the trailer 102. For example, the trailer lines 108 may include one or more air hoses 110 (FIG. 2) that may connect a compressor 112 positioned in, or associated with, the truck 104 to a brake system 114 of the trailer 102, such as, an emergency brake system, an air brake system, and/or the trailer service brakes. Additionally, and/or alternatively, the trailer lines 108 may include an electrical line 118 (FIG. 2) connecting a power source 120, e.g., a battery, contained in the truck 104 to electrical components 122, e.g., lights, temperature control systems, etc., connected to, or associated with, the trailer 102. Additional or alternative trailer lines 108 may be envisioned for use with the positioning system 106.

Each of the trailer lines 108 includes a distal end 124 that includes a line connector 126 that may be selectively connected or disconnected to a corresponding trailer connector 128 associated with the trailer 102. In some embodiments, each of the individual trailer lines 108 includes an individual line connector 126 for connecting with a corresponding individual trailer connector 128. Alternatively, the trailer lines 108 may share a single line connector 126 for connecting to a single trailer connector 128.

In embodiments described herein, the positioning system 106 includes a positionable hose 130, a computing system 132 or a visual detection system 134. The computing system 132 may receive visual data detected by the visual detection system 134, and using the visual data, the computing system 132 determines one or more control signals to control the positionable hose 130, as described in further detail herein.

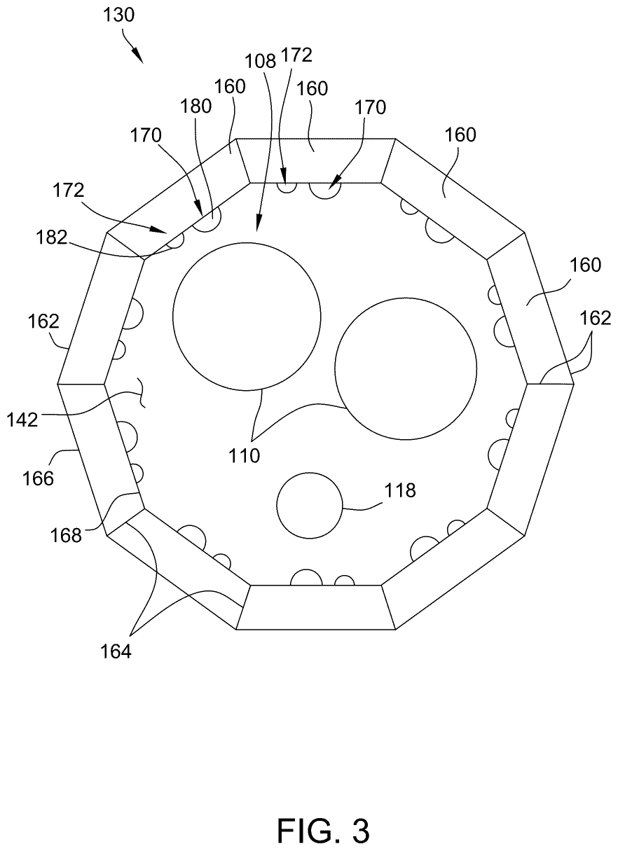

In reference to FIGS. 2 and 3, in embodiments described herein, the positionable hose 130 defines an interior cavity 142 extending along a length L₁₄₀ of the positionable hose 130. The interior cavity 142 is sized and shaped to contain or hold one or more of the trailer lines 108 therein, e.g., one or more air hoses 110 and/or electrical lines 118. The positionable hose 130 may include a proximal end 150 that is connected or supported by the truck 104 and a distal or free end 152. See FIG. 1. One or more line connectors 126 may be exposed from the distal end 152 of the positionable hose 130 for connecting to the trailer connector 128.

The positionable hose 130 includes a plurality of billows 160 each having a hollow billow chamber, not visible, such that the billows 160 may be selectively inflated or deflated, thereby selectively adjusting the rigidity of the billow 160. The billows 160 may be formed of a fabric of flexible material that may stretch slightly during inflation. The billows 160 may be formed of nylon, Kevlar, polyurethane, poly vinyl chloride, polythene, high density polythene, etc. for example. In some embodiments, the billows 160 share one or more walls 162 with one or more adjacent billows 160. Billows 160 may be arranged generally in rows and columns, e.g., a row referring to a circumferential arrangement of a plurality of billows 160 and a column referring to an axial arrangement of a plurality of billows 160. In some embodiments, each of the billows 160 includes four side walls 164, e.g., which may be shared with adjacent billows 160, an outer wall 166 facing outside the positionable hose 130 and an inner wall 168 that faces the interior cavity 142 of the positionable hose 130. For example, the inner wall 168 of the plurality of billows 160 defines a boundary of the interior cavity 142.

Each of the billows 160 further includes an inlet 170 defining an opening, not visible, for fluid to enter into the billow chamber, e.g., to inflate the billow 160. Each of the billows 160 further includes an outlet 172 defining an opening, not visible, for releasing fluid from within the billow chamber, e.g., to deflate the billow 160. In some embodiments, the inlet 170 and the outlet are positioned through the outer wall 166 of the billows 160. See FIG. 2, for example. In some embodiments, the inlet 170 and the outlet are positioned through the inner wall 168 of the billows 160. See FIG. 3, for example.

In some embodiments, the outlet, and the inlet 170 are disposed on opposing sides of the billow 160. For example, the inlets 170 may be disposed on the inner wall 168 and the outlets may be disposed on the outer wall 166.

The positionable hose 130 further includes an inlet line 180 and/or an outlet line 182, e.g., a hollow tube or hose. The inlet line 180 may be fluidically coupled at a first end to a compressed fluid source 184 (e.g., compressor 112 or a separate compressor) and fluidically coupled at a second end to the inlet 170, such that the inlet 170 line delivers compressed fluid from the compressed fluid source into the billow 160, e.g., to inflate the billow 160. If the inlets 170 are disposed on the inner wall 168, the inlet lines 180 may be disposed within the interior cavity 142 (see FIG. 3), likewise, if the inlets 170 are disposed on the outer wall 166, the inlet line 180 may disposed outside of the interior cavity 142 (see FIG. 2).

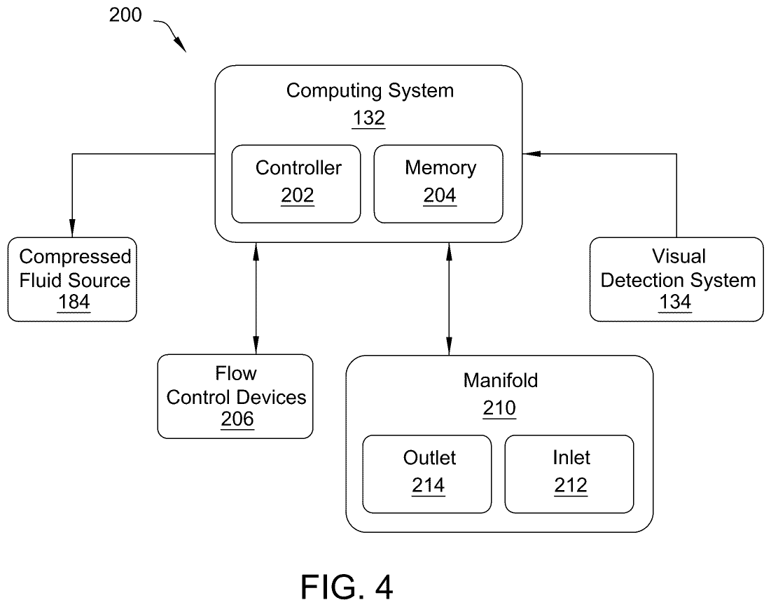

FIG. 4 is a block diagram of a control system 200 for use with the positionable hose system 106. The control system 200 includes the computing system 132, which may include a processor 202 and a memory 204.

In some embodiments, the positionable hose system 106 may include one or more flow control devices 206, such as flow meters or controllable valves, etc. that may be communicatively coupled to the computing system 132. The computing system 132 may transmit one or more signals to the flow control devices 206 to adjust a flow parameter, such as a mass flow rate, a flow rate, a mass, a velocity, a pressure, etc. of fluid flowing through the inlet line 180 and/or the outlet line 182 or flowing into the inlet 170 or flowing out of the outlet 172.

In some embodiments, the positionable hose system 106 and/or the control system 200 includes a manifold 210 having at least one manifold inlet 212 and a plurality of manifold outlets 214. The manifold inlet 212 is communicatively coupled to the compressed fluids source 184 and the plurality of manifold outlets 214 are connected to the plurality of inlet lines 180. The manifold 210 may include one or more of the flow control devices 206, enabling the computing system 132 to selectively adjust a flow parameter of fluid passing out of each of the plurality of manifold outlets 214 and into each of the inlet lines 180.

In some embodiments, the positionable hose 130 further includes one or more passive valves, e.g., a one-way valve, not shown, positioned within the inlet line 180 or outlet line 182. In some embodiments, the passive valves may be positioned within the inlet 170 and/or the outlet 172. The valves may block or restrict the flow of the fluid in one direction. For example, one or more valves positioned within the inlet line 180 and/or within the inlet 170, allow flow to move towards or into the billow 160, but prevent flow in the opposite direction, e.g., out of the billow 160. Similarly, one or more valves may be positioned within the outlet line 182 or the outlet 172 and prevent fluid from entering the billow 160.

In some embodiments, the outlet 172 is not connected to the outlet line 182, e.g., the outlet 172 selectively releases fluid within the billow 160 to the surrounding or ambient air. In some embodiments, the passive valve restricts fluid exiting the outlet 172, until the air pressure in the billow 160 exceeds a threshold. For example, the passive valve may substantially block fluid from exiting the billow 160, unless the fluid pressure in the billow 160 exceeds a threshold level which may force the passive valve to open.

The computing system 132 may selectively inflate or deflate billows 160 in order to position the positionable hose 130. For example, to generally bend/flex the positionable hose 130 to the right, the computing system 132 may selectively inflate one or more of the billows 160 on a left side of the positionable hose 130 while simultaneously deflating one or more billows 160 on the right side of the positionable hose 130.

In some embodiments, the computing system 132 is also communicatively coupled to the compressed fluid source 184, the compressor 112, and/or the power source 120. In some embodiments, the computing system 132 ensures that the trailer lines 108 are turned off or disabled while the positionable hose system 106 is positioning and/or connecting the line connector 126 to the trailer connector 128, and then subsequently, after confirmation that the positionable hose 130 is connected, the computing system 132 may turn on or enable the trailer lines 108, automatically. In some embodiments, the computing system 132 may transmit one or more messages, e.g., to a vehicle computing system, indicating, or confirming that the line connector 126 is connected to the trailer connector 128.

The visual detection system 134 may include a camera for capturing images of the positionable hose 130 and/or the trailer connector 128. The visual detection system 134 may continuously, or periodically with a suitable data collection rate, capture images of the positionable hose 130 as the positionable hose 130 is moved and positioned, to provide feedback to the computing system 132 regarding the real-time position of the positionable hose 130 and/or the relative position of the line connector 126 and the trailer connector 128. In some embodiments, the visual detection system 134 may include a position sensor, not shown, that is communicatively coupled to the computing system 132. The position sensor may detect a position or movement of the positionable hose 130 or the position sensor may detect and/or confirm the connection between the trailer connector 128 and the line connector 126. The position sensor may include a hall sensor or magnetic sensor.

The computing system 132 transmits one or more signals to the flow control devices 206 to control a flow parameter, e.g., mass flow rate, velocity, pressure etc., of fluid flowing through the inlet lines 180 to control the amount of fluid flowing into the billow 160 to selectively adjust the amount of inflation of the billow 160. In some embodiments, the computing system 132 is communicatively coupled to the compressed fluid source 184, e.g., compressor 112, directly, the computing system 132 may transmit one or more signals to the compressed fluid source 184 to adjust a flow parameter of the compressed fluid source 184, e.g., turn or off the compressed fluid source 184 or adjust the amount of pressure of the fluid.

In some embodiments, the computing system 132 is communicatively coupled to one or more components associated with the truck 104, e.g., autonomous truck. For example, the computing system 132 may be communicatively coupled to the power source 120 of the truck 104. The computing system 132 may transmit one or more signals to the power source to selectively turn on or off the power source.

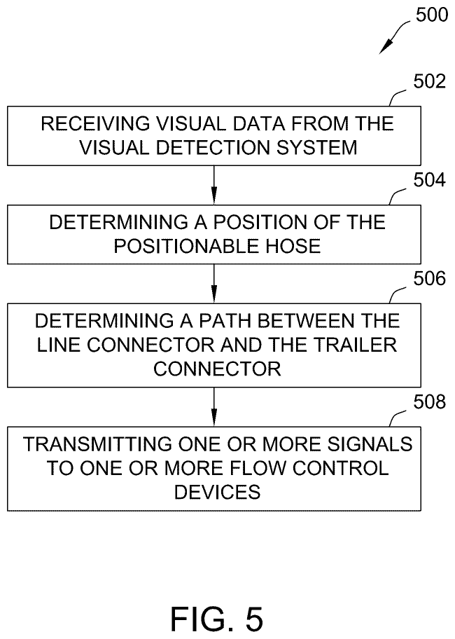

FIG. 5 is a process flow diagram for positioning and connecting the positionable hose system 106. One or more steps of method 500 may be implemented using the computing system 132, or any other suitable computing device. Method 500 may include the computing system 132 receiving 502 one or more signals, e.g., visual data, from the visual detection system 134. In some embodiments, method 500 may include the computing system 132 determining 504 a position of the positionable hose 130, a position of the line connectors 126, the position of the trailer connector 128, and/or a relative location of the line connector 126 and the trailer connector 128 using, at least in part, the visual data received from the visual detection system 134. In some embodiments, method 500 includes the computing system 132 evaluating the visual data using one or more analytical processes. In some embodiments, method 500 includes the computing system 132 determining 506 one or more paths for moving the positionable hose 130 to position and/or connect the line connector 126 to the trailer connector 128. Method 500 may include the computing system 132 determining an inflation and/or a deflation arrangement for a plurality of billows 160.

Method 500 further includes the computing system 132 transmitting 508 one or more signals to one or more flow control devices 206 to adjust a flow parameter of flow passing through the inlet lines 180 and into the billows 160.

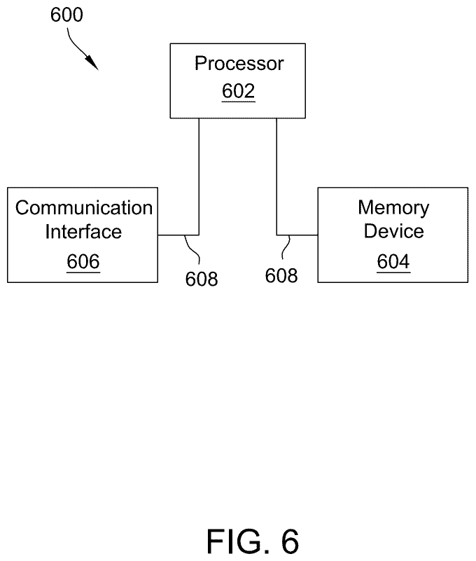

FIG. 6 is a block diagram of an example computing device 600. Computing device 600 includes a processor 602 and a memory device 604. The processor 602 is coupled to the memory device 604 via a system bus 608. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 604 includes one or more devices that enable information, such as executable instructions or other data (e.g., sensor data), to be stored and retrieved. Moreover, the memory device 604 includes one or more computer readable media, such as, without limitation, dynamic random-access memory (DRAM), static random-access memory (SRAM), a solid state disk, or a hard disk. In the example embodiment, the memory device 604 stores, without limitation, application source code, application object code, configuration data, additional input events, application states, assertion statements, validation results, or any other type of data. The computing device 600, in the example embodiment, may also include a communication interface 606 that is coupled to the processor 602 via system bus 608. Moreover, the communication interface 606 is communicatively coupled to data acquisition devices.

In the example embodiment, processor 602 may be programmed by encoding an operation using one or more executable instructions and providing the executable instructions in the memory device 604. In the example embodiment, the processor 602 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) automatically positioning trailer lines between a truck and a trailer (b) automatically connecting a line connector to a trailer connector, and/or (c) controlling and positioning a positionable hose using merely a compressed fluid source.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the term's processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for positioning of one or more trailer lines for connecting a truck to a trailer, wherein the system comprises:
a positionable hose including a plurality of billows, the positionable hose defining an interior cavity extending along a length of the positionable hose, the interior cavity is sized and shaped to contain one or more of the trailer lines therein, each of the billows includes a billow inlet;
a compressed fluid source for generating a compressed fluid flow; and
an inlet line fluidically connected to the compressed fluid source and the billow inlet, wherein the inlet line supplies the compressed fluid flow from the compressed fluid source through the billow inlet and into the billow to inflate the billow.

2. The system of claim 1, wherein the system further comprises a visual detection system comprising a camera positioned to detect a position of the positionable hose.

3. The system of claim 1, wherein the trailer lines comprise at least one air hose and an electrical line.

4. The system of claim 1, wherein each of the billows shares a wall with an adjacent billow.

5. The system of claim 1, wherein the system further comprises one or more flow control devices configured to control a flow parameter of the compressed fluid flow.

6. The system of claim 1, wherein each of the plurality of billows includes an outlet for releasing air from within the billow to deflate the billow.

7. The system of claim 1, wherein the billow inlet is positioned on an inner wall of the billows facing the interior cavity.

8. The system of claim 1, wherein the system further comprises a passive valve to restrict the compressed fluid flow to one direction.

9. The system of claim 1, wherein the compressed fluid source is an air compressor associated with the truck, wherein the compressed fluid source also supplies compressed air to air brakes of the trailer when the trailer lines are connected to the trailer.

10. A control system for positioning of one or more trailer lines for connecting a truck to a trailer, wherein the control system comprises:
a positionable hose including a plurality of billows, the positionable hose defining an interior cavity extending along a length of the positionable hose, the interior cavity is sized and shaped to contain one or more of the trailer lines therein, each of the billows includes a billow inlet;
a compressed fluid source for generating a compressed fluid flow; and
an inlet line fluidically connected to the compressed fluid source and the billow inlet, wherein the inlet line supplies the compressed fluid flow from the compressed fluid source through the billow inlet and into the billow to inflate the billow;
a flow control device for controlling a flow parameter of the compressed fluid flow within the inlet line; and
a computing system communicatively coupled to the flow control device, the computing system transmitting a control signal to the flow control device to adjust a flow parameter of the compressed fluid flow.

11. The control system of claim 10, wherein the system further comprises a visual detection system comprising a camera positioned to detect a position of the positionable hose.

12. The control system of claim 10, wherein the trailer lines comprise at least one air hose and an electrical line.

13. The control system of claim 10, wherein each of the billows shares a wall with an adjacent billow.

14. The control system of claim 10, wherein each of the plurality of billows includes an outlet for releasing air from within the billow to deflate the billow.

15. The control system of claim 14, wherein the outlet is positioned on an outer wall of the billow.

16. The control system of claim 10, wherein the billow inlet is positioned on an inner wall of the billows facing the interior cavity.

17. The control system of claim 14, wherein the system further comprises a passive valve positioned within the outlet to restrict the compressed fluid flow to one direction.

18. The control system of claim 10, wherein the system further comprises a passive valve positioned within the inlet line to restrict the compressed fluid flow to one direction.

19. The control system of claim 10, wherein the system further comprises a passive valve positioned within the billow inlet to restrict the compressed fluid flow to one direction.

20. A method for positioning a positionable hose for connecting a line connector to a trailer connector, the method comprising:
receiving, at a computing device, visual data from a visual detection system;
determining, using the computing device, a position of the positionable hose and a position of the trailer connector; and
transmitting, from the computing device to a flow control device, a control signal, the control signal causing the flow control device to adjust a parameter of a compressed fluid flow supplied to the positionable hose.
